(19) United States
(12) Patent Application Publication
(10) Pub. No.: US 2007/0265754 A1
(43) Pub. Date: Nov. 15, 2007

(54) METHOD FOR AUTOMATICALLY ADJUSTING SEATS IN VEHICLES BASED UPON CARGO SIZE

(76) Inventors: Bryce Allen Curtis, Round Rock, TX (US); Vincent J. Meriwether, Round Rock, TX (US)

Correspondence Address: IBM CORP (YA);C/O YEE & ASSOCIATES PC, P.O. BOX 802333, DALLAS, TX, 75380, US

(21) Appl. No.: 11/382,294

(22) Filed: May 9, 2006

(51) Int. Cl. G06F 17/00

(52) U.S. Cl. 701/49; 701/1

(57) ABSTRACT

A computer implemented method, a computer program product and a data processing system for adjusting cargo space within a vehicle is provided. An identity tag for an item is scanned using a reader and transmitted to a vehicle, where it is received. Dimension information for the item is retrieved. A determination is made as to whether the items will fit in the cargo space of the vehicle. In response to a determination that the item will fit into the cargo space of the vehicle, the best fit for the item is calculated. Seats within the vehicle are reconfigured to accommodate the item within the cargo space.

### BACKGROUND OF THE INVENTION

1. Field of the Invention

The present invention relates generally to an improved method for loading items into a vehicle. Still more particularly, the present invention relates to a system, computer usable program code, and computer implemented method for adjusting cargo space within a vehicle.

2. Description of the Related Art

Often, loading large items, such as lumber, into a vehicle, with moveable or adjustable rear seats, the user must manually adjust or fold the seats before loading the cargo. The user may have to fold and/or adjust the seats more than once for particularly bulky items, until the user achieves the needed amount of cargo space. Therefore, a way to automatically have the seats fold or adjusted out of the way based upon the size of the cargo is needed.

### SUMMARY OF THE INVENTION

A computer implemented method, a computer program product and a data processing system for adjusting cargo space within a vehicle is provided. Dimension information for the item is retrieved. A calculation is made as to whether the items will fit in the cargo space of the vehicle. In response to a calculation that the item will fit into the cargo space of the vehicle, the seats within the vehicle are reconfigured to accommodate the item in the cargo space.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which exemplary aspects may be implemented;

FIG. 2 is a block diagram of a data processing system is shown in which exemplary aspects may be implemented;

FIG. 3 is a block diagram depicting a system for adjusting cargo space within a vehicle in accordance with an exemplary embodiment;

FIGS. 4A and 4B are pictorial representations of a vehicle and a RFID reader, in accordance with exemplary embodiments; and

FIG. 5 is a flowchart illustrating the operation of adjusting seats to reconfigure cargo space in a vehicle.

### DETAILED DESCRIPTION OF THE PREFERRED EMBODIMENT

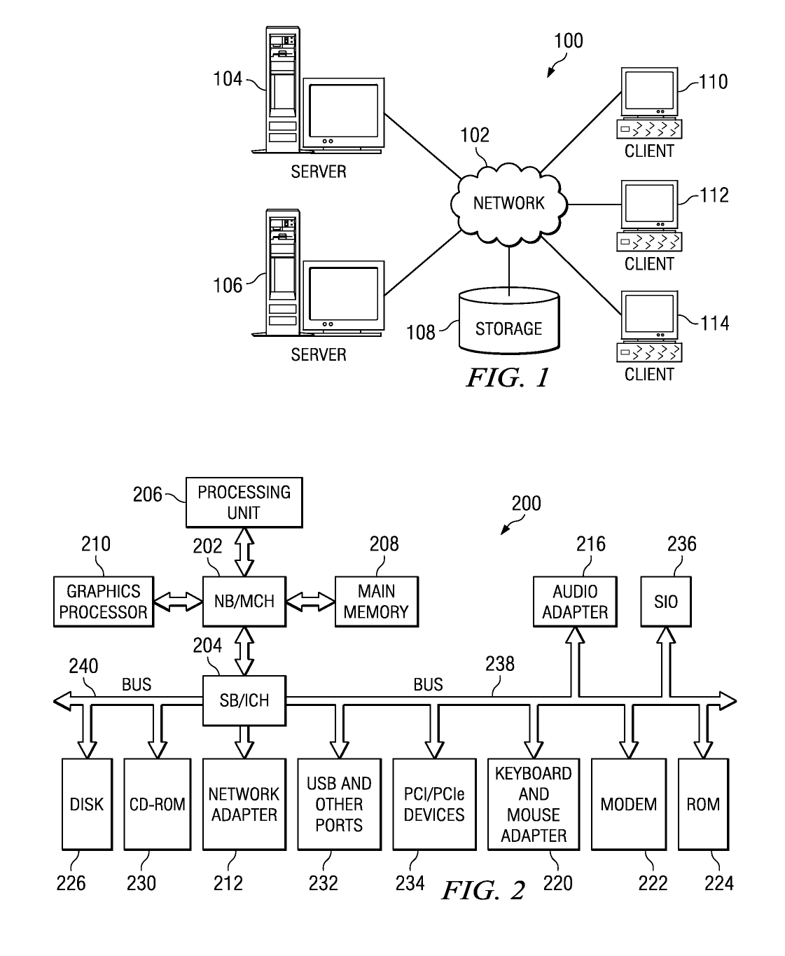

FIGS. 1-2 are provided as exemplary diagrams of data processing environments in which exemplary aspects may be implemented. It should be appreciated that FIGS. 1-2 are only exemplary and are not intended to assert or imply any limitation with regard to the environments in which exemplary aspects or embodiments may be implemented. Many modifications to the depicted environments may be made without departing from the spirit and scope.

With reference now to the figures, FIG. 1 depicts a pictorial representation of a network of data processing systems in which exemplary aspects may be implemented. Network data processing system 100 is a network of computers in which exemplary aspects may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which exemplary aspects may be implemented. Data processing system 200 is an example of a computer, such as server 104 or client 110 in FIG. 1, in which computer usable code or instructions implementing the processes for embodiments may be located.

In the depicted example, data processing system 200 employs a hub architecture including north bridge and memory controller hub (NB/MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Exemplary embodiments enable electronically controlled seating in a vehicle to be automatically folded or moved out of the way to make space for large items. The item is identified by the vehicle, its size determined, and the seats are automatically adjusted to accommodate the item.

When loading large items into a vehicle with moveable rear seats (such as an SUV, mini-van, or van), the user, typically, must manually fold or move the seats before loading the cargo. By automatically adjusting the seats based upon cargo size, the cargo can be easily loaded. When the cargo is removed, the original position of the seats can be restored. A vehicle is activated by unlocking a door or other indication that the user has returned to the vehicle. The vehicle determines the item(s) that the user has at hand when returning to vehicle. This can be done automatically by using an RFID tag, bar code, or another tagging mechanism, and an appropriate tag reader. An RFID is a radio frequency identification and a RFID tag is a radio frequency identification tag.

The tags are included on items, such as those purchased at a store. The item size may be included on the tag, or may be found by using the information provided on the tag as a lookup reference. The reader determines the quantity of items as well as size dimensions. Once the size of the cargo is known, the vehicle determines if any seats need to be adjusted.

Since the vehicle knows the dimensions and seat configurations of the vehicle itself, the appropriate seat(s) can be adjusted. Before adjusting seats, the vehicle must know which seats can be moved. The factors to consider are whether someone is sitting in the seat, or if there is an object, such as a baby seat installed.

Indicators may include whether the seatbelt is latched, weight sensor in the seats, or other mechanism. When the cargo is removed from the vehicle, the seats are returned to their original position.

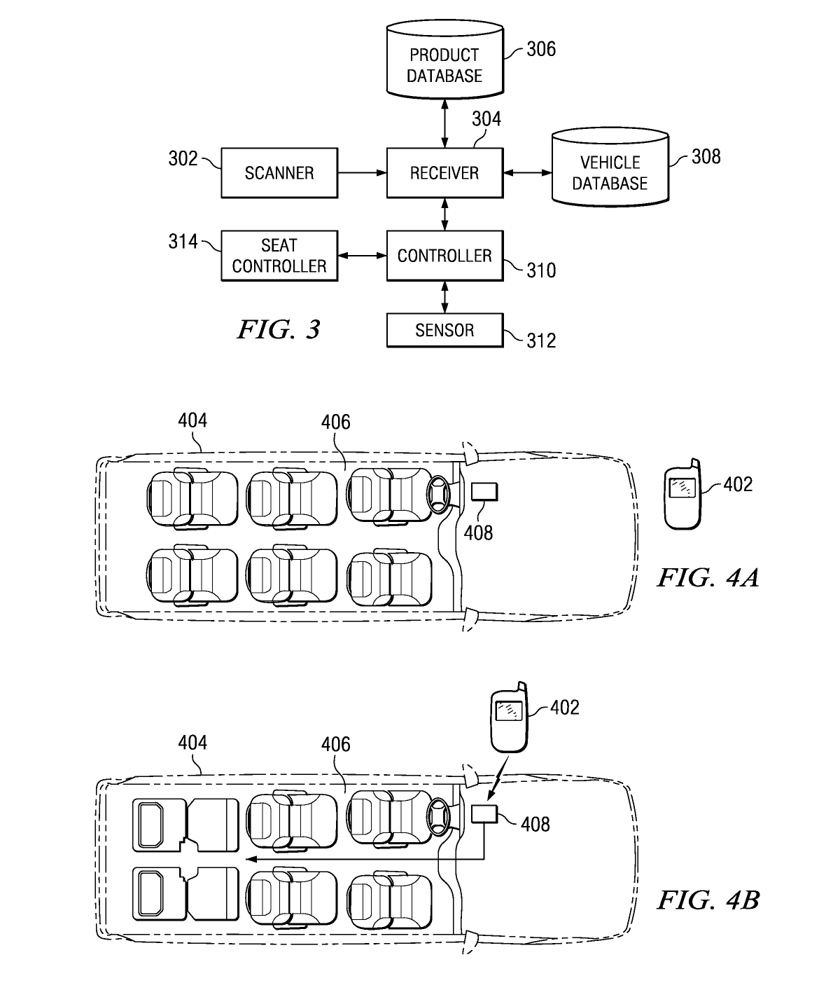

FIG. 3 is a block diagram depicting a system for adjusting cargo space within a vehicle in accordance with an exemplary embodiment. Scanner 302 scans the information or identification tag on the item to be loaded into the vehicle. Scanner 302 may be a bar code scanner or an RFID scanner or any other appropriate type of scanner. An RFID scanner is a radio frequency identification scanner that scans RFID tags. The scanned information is transmitted to receiver 304. Receiver 304 then looks up the item in product database 306 to determine the dimensions and weight of the item. Receiver 304 and product database 306 may be implemented as part of a data processing system, such as data processing system 200 in FIG. 2. Dimensions include height, length, and width. In an alternate embodiment, product database 306 is maintained by the retail store or location of the item and receiver 304 communicates wirelessly with the database to get the necessary information. In another embodiment, product database 306 is maintained on the internet or in cyberspace and receiver 304 communicates wirelessly with the database to get the necessary information. In another, product database 306 is maintained by the individual vehicle. In another embodiment, there is no product database as the information about the item, including all dimensions and weight are part of the tag. Therefore, when scanner 302 scans the tag, the dimensional and weight information is already transmitted and available to receiver 304.

Receiver 304 also looks up the vehicle size and cargo space and configuration in a vehicle database. In an alternate embodiment, the vehicle cargo space and configuration information is maintained by the vehicle by either receiver 304 or controller 310. Receiver 304 then compares the item dimensions to the vehicle cargo dimension and configuration to determine if the item will fit into the vehicle. If receiver 304 determines that the item will not fit into the cargo space of the vehicle, receiver 304 informs the user of the error. This could take the form of an audible signal or some visual indication such as a flashing light or “no load” sign lighting up.

If receiver 304 determines that the item will potentially fit into the vehicle, receiver 304 determines what seat configuration is necessary to allow the loading of the item into the vehicle. Receiver 304 passes this configuration information to controller 310. Controller 310 then checks sensors 312 to determine if the seats may be reconfigured. Sensors 312 determine if the seats are occupied. Sensors 312 may be implemented in various ways, including, but not limited to, weight sensors in the seats or seatbelt sensors. In the case of seatbelt sensors, if the sensors determine that a seatbelt is buckled, then the assumption is made that someone or some object is occupying the seat in question. Therefore the seat cannot be adjusted. If sensors 312 indicate that a seat is occupied and cannot therefore be adjusted, controller 310 passes this information back to receiver 304. Receiver 304 then determines if there is an alternate configuration of the seats that will still allow the item to be loaded into the cargo space of the vehicle.

If receiver 304 determined that there is not another possible viable configuration of the seats, then receiver 304 informs the user of the error. This could take the form of an audible signal or some visual indication such as a flashing light or “no load” sign lighting up. This signal maybe the same signal as the signal that indicates that the item cannot fit into the vehicle cargo space or the signal may be different. A different signal would inform the user that a configuration had been attempted but failed because a seat was occupied. Thereby, the user could adjust other items in the vehicle, possibly emptying the occupied seat, and try the process again.

If receiver 304 determined that there is another possible viable configuration of the seats, then receiver 304 passes this configuration information to controller 310 and controller 310 repeats the process of trying to adjust the seats to allow the item to be loaded.

If controller 310 determines that the seats may be adjusted, then controller 310 sends commands to seat controller 314 to adjust the various seats to conform to the configuration necessary to allow the item to fit into the cargo space of the vehicle. Seat controller 314 may be located at each individual seat and controls the adjustment of the seats. In an alternative exemplary embodiment, seat controller 314 is part of controller 310, and controller 310 and seat controller 314 simply send commands to the various motors controlling the adjustment of the seats to have the seats adjusted and reconfigured.

In an alternate embodiment, controller 310 performs many of the functions described above as being performed by receiver 304, including retrieving information from product database 306 and vehicle database 308, determining whether the item will fit into the vehicle, and determining various seat configurations. In another embodiment receiver 304 and controller 310 are part of a single device.

FIGS. 4A and 4B are pictorial representations of a vehicle and a RFID reader, in accordance with exemplary embodiments. FIG. 4A shows RFID reader 402, vehicle 404 with seats 406 and adjusting system 408, located in the dashboard area. Vehicle 404 is in an original configuration with seats 406 in a normal, upright position. FIG. 4B shows the same vehicle 402 with a modified configuration. RFID reader 402 communicates with adjusting system 408 regarding an item tag that has just been scanned or read. In the present example, adjusting system 408, which may be implemented as system 300 in FIG. 3 is located in the dashboard of vehicle 404. Adjusting system 408 then adjusts and reconfigures seats 406 to allow the item to fit into the cargo space.

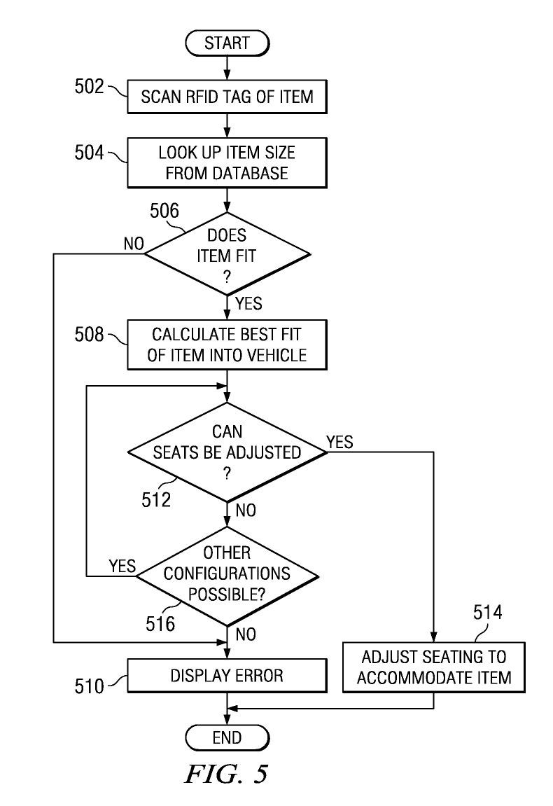

FIG. 5 is a flowchart illustrating the operation of adjusting seats to reconfigure cargo space in a vehicle according to an exemplary embodiment. The operation begins when the user scans an RFID tag of the item to be stored in the cargo space of the vehicle (step 502). Next, the operation looks up the item size from a database (step 504). Alternately, the item size could be included as information on the RFID tag. The operation determines if the item will potentially fit into the cargo space of the vehicle (step 506). If the item will not fit into the cargo space of the vehicle (a no output to step 506), an error message is displayed to the user (step 510) and the operation ends. If the item will fit into the cargo space of the vehicle (a yes output to step 506), the operation determines the best fit for the item (step 508). The operation then determines if the seats that need to be adjusted to accommodate the item can be moved (step 512). If the operation determines that the seats can be adjusted to accommodate the item (a yes output to step 512), then the operation adjusts the seats to accommodate the item (step 514) and the operation ends.

If the operation determines that the seats cannot be adjusted to accommodate the item (a no output to step 512), then the operation determines if there is another possible configuration of the cargo space that can accommodate the item (step 516). If the operation determines that there is not another possible configuration of the cargo space that can accommodate the item (a no output to step 516), then the operation displays an error message to the user (step 510) and operation ends. If the operation determines that there is another possible configuration of the cargo space that can accommodate the item (a yes output to step 516), then the operation returns to step 512 and determines if the seats that need to be adjusted to accommodate the item can be moved.

Thus, exemplary embodiments provide for the automatic adjustment of seats in a vehicle to allow for increased cargo space in order to accommodate loading large items in the vehicle.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for adjusting cargo space within a vehicle, the computer implemented comprising:
retrieving dimension information regarding the item;
calculating if the item will fit into the cargo space of a vehicle; and
in response to a calculation that the item will fit into the cargo space of the vehicle, reconfiguring seats in the vehicle to accommodate the item.

2. The computer implemented method of claim 1, further comprising:
scanning a tag for the item.

3. The computer implemented method of claim 2, further comprising:
wherein the tag for the item contains an identification for the item and wherein the identification for the item includes dimension information for the item; and
wherein retrieving dimension information regarding the item comprises looking up the identification for the item.

4. The computer implemented method of claim 2, wherein the tag for the item contains dimensional information for the item.

5. The computer implemented method of claim 2, wherein the tag for the item is a radio frequency identity tag.

6. The computer implemented method of claim 2, wherein the tag for the item is a barcode tag.

7. The computer implemented method of claim 1, further comprising:
in response to a calculation that the item will fit into the cargo space of the vehicle, calculating the best fit for the item.

8. The computer implemented method of claim 1, further comprising:
determining if the seats that need to be reconfigured are available to be reconfigured.

9. The computer implemented method of claim 8, wherein the step of determining if the seats that need to be reconfigured are available to be reconfigured comprises:
checking sensors to determine if the seats are occupied.

10. The computer implemented method of claim 9, wherein the sensors are weight sensors in the seats.

11. The computer implemented method of claim 9, wherein the sensors are seatbelt sensors for the seats.

12. The computer implemented method of claim 8, further comprising:
in response to a determination that the seats that need to be reconfigured are not available to be reconfigured, determining if another possible configuration of the cargo space exists that can accommodate the item.

13. The computer implemented method of claim 12, further comprising:
in response to a determination that the seats that another possible configuration of the cargo space that can accommodate the item does not exist, sending an error message to a user.

14. The computer implemented method of claim 1, further comprising:
in response to a determination that the item will not fit into the cargo space of the vehicle, sending an error message to a user.

15. A computer program product comprising a computer usable medium including computer usable program code for adjusting cargo space within a vehicle, the computer program product comprising:
computer usable program code for retrieving dimension information regarding the item;
computer usable program code for calculating if the item will fit into the cargo space of a vehicle; and
computer usable program code, in response to a calculation that the item will fit into the cargo space of the vehicle, for reconfiguring seats in the vehicle to accommodate the item.

16. The computer program product of claim 15, further comprising:
computer usable program code for scanning a tag for the item.

17. The computer program product of claim 16, further comprising:
wherein the tag for the item contains an identification for the item and wherein the identification for the item includes dimension information for the item; and
wherein the computer useable program code for retrieving dimension information regarding the item comprises computer useable program code for looking up the identification for the item.

18. The computer program product of claim 16, wherein the tag for the item contains dimensional information for the item.

19. The computer program product of claim 14, wherein the tag for the item is a radio frequency identity tag.

20. A data processing system for adjusting cargo space within a vehicle, the data processing system comprising:
a storage device, wherein the storage device stores computer usable program code; and
a processor, wherein the processor executes the computer usable program code to receive an identification for an item; retrieve dimension information regarding the item; calculate if the item will fit into the cargo space of a vehicle; in response to a calculation that the item will fit into the cargo space of the vehicle, reconfigure seats in the vehicle to accommodate the item.
